(19) United States
(12) Patent Application Publication
(10) Pub. No.: US 2026/0228353 A1
(43) Pub. Date: Aug. 6, 2026

(54) IN-VEHICLE DEVICE, INFORMATION PROCESSING METHOD, AND IN-VEHICLE SYSTEM

(71) Applicants: NATIONAL UNIVERSITY CORPORATION TOKAI NATIONAL HIGHER EDUCATION AND RESEARCH SYSTEM, Nagoya-shi, Aichi (JP); AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Ryo KURACHI, Nagoya-shi, Aichi (JP); Hiroaki TAKADA, Nagoya-shi, Aichi (JP); Hiroshi UEDA, Yokkaichi-shi, Mie (JP)

(73) Assignees: NATIONAL UNIVERSITY CORPORATION TOKAI NATIONAL HIGHER EDUCATION AND RESEARCH SYSTEM, Nagoya-shi, Aichi (JP); AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 19/148,290

(22) PCT Filed: Dec. 28, 2023
(86) PCT No.: PCT/JP2023/047307

§ 371 Date: Jul. 15, 2025

(30) Foreign Application Priority Data
Jan. 16, 2023 (JP) 2023-004583

(51) Int. Cl. G06F 21/62

(52) U.S. Cl. CPC G06F 21/6218

(57) ABSTRACT

An in-vehicle device is an in-vehicle device communicatively connected to an in-vehicle ECU mounted in a vehicle, the in-vehicle device including a controller configured to perform processing related to a service request from the in-vehicle ECU, wherein the controller is configured to acquire request data related to the service request from the in-vehicle ECU, specify a service provided to the in-vehicle ECU and a security level when providing the service based on the acquired request data, generate provision data for providing a service to the in-vehicle ECU based on the specified security level, and output the generated provision data to the in-vehicle ECU.

### CROSS-REFERENCE TO RELATED APPLICATIONS

This application is the U.S. national stage of PCT/JP2023/047307 filed on Dec. 28, 2023, which claims priority of Japanese Patent Application No. JP 2023-004583 filed on Jan. 16, 2023, the contents of which are incorporated herein.

### TECHNICAL FIELD

The present disclosure relates to an in-vehicle device, an information processing method, and an in-vehicle system.

### BACKGROUND ART

Conventionally, the Controller Area Network (CAN) communication protocol has been widely adopted as a communication protocol used for communication between a plurality of devices such as ECUs (Electronic Control Units) mounted in a vehicle.

Japanese Patent Application No. 2009-220800 proposes an integrated detection and control device that is connected to a CAN of a vehicle, causes in-vehicle equipment to perform an operation according to a device diagnosis command, imports state response data transmitted by the in-vehicle equipment, and determines an operating state of the in-vehicle equipment.

The integrated detection and control device of Japanese Patent Application No. 2009-220800 does not take into consideration generating and outputting provision data undergoing appropriate security processing for request data related to a service request when the request data is transmitted from an in-vehicle ECU (Electronic Control Unit).

### SUMMARY

An in-vehicle device according to an aspect of the disclosure is an in-vehicle device communicatively connected to an in-vehicle ECU mounted in a vehicle, the in-vehicle device including a controller configured to perform processing related to a service request from the in-vehicle ECU, wherein the controller is configured to acquire request data related to the service request from the in-vehicle ECU, specify a service provided to the in-vehicle ECU and a security level when providing the service based on the acquired request data, generate provision data for providing a service to the in-vehicle ECU based on the specified security level, and output the generated provision data to the in-vehicle ECU.

An object of the disclosure is to provide an in-vehicle device, etc. capable of generating and outputting provision data undergoing appropriate security processing for request data related to a service request when the request data is transmitted from an in-vehicle ECU.

### Effects of the Disclosure

According to an aspect of the disclosure, it is possible to provide an in-vehicle device, etc. that generates provision data undergoing appropriate security processing for request data related to a service request when the request data is transmitted from an in-vehicle ECU.

### BRIEF DESCRIPTION OF DRAWINGS

FIG. 1 is a schematic diagram illustrating a configuration of an in-vehicle system including an in-vehicle device according to Embodiment 1.

FIG. 2 is a block diagram illustrating a physical configuration of the in-vehicle device.

FIG. 3 is an explanatory diagram illustrating a service table.

FIG. 4 is an explanatory diagram illustrating a security processing table.

FIG. 5 is an explanatory diagram illustrating a protected SOME/IP message.

FIG. 6 is an explanatory diagram illustrating a processing sequence between an in-vehicle device (server) and an in-vehicle ECU (client).

FIG. 7 is a flowchart illustrating processing of a controller of the in-vehicle device.

FIG. 8 is an explanatory diagram illustrating a processing sequence between an in-vehicle device (server) and an in-vehicle ECU (client) related to Embodiment 2 (dynamic change of a security level).

FIG. 9 is a flowchart illustrating processing of a controller of the in-vehicle device.

FIG. 10 is a functional block diagram illustrating functional units included in a controller of an in-vehicle device related to Embodiment 3 (inter-process communication in the in-vehicle device).

### DETAILED DESCRIPTION OF PREFERRED EMBODIMENTS

First, embodiments of the disclosure will be listed and described. In addition, at least some of the embodiments described below may be arbitrarily combined.

An in-vehicle device according to an aspect of the disclosure is an in-vehicle device communicatively connected to an in-vehicle ECU mounted in a vehicle, the in-vehicle device including a controller configured to perform processing related to a service request from the in-vehicle ECU, wherein the controller is configured to acquire request data related to the service request from the in-vehicle ECU, specify a service provided to the in-vehicle ECU and a security level when providing the service based on the acquired request data, generate provision data for providing a service to the in-vehicle ECU based on the specified security level, and output the generated provision data to the in-vehicle ECU.

In this aspect, the in-vehicle device and the in-vehicle ECU mounted in the vehicle communicate with each other via an in-vehicle network, and perform communication related to a request and provision of a service executed by the in-vehicle device. For example, the in-vehicle device that handles processing related to a rear camera executes a service that outputs an image (service instance) captured by the rear camera via the in-vehicle network. The in-vehicle ECU can receive a service related to the rear camera from the in-vehicle device by requesting the service from the in-vehicle device, and can execute various applications such as a human detection process in the rear by using a service instance (for example, an image of the rear camera) acquired from the in-vehicle device. Alternatively, the in-vehicle device may specify a service to be provided according to the application name by acquiring request data including an application name corresponding to the service from the in-vehicle ECU. When performing communication processing related to the request and provision of such a service, the controller of the in-vehicle device specifies not only the service to be provided to the in-vehicle ECU but also the security level when providing the service based on the request data (data related to the service request) from the in-vehicle ECU. The controller of the in-vehicle device generates provision data in response to the request data based on the specified security level and outputs the generated provision data to the in-vehicle ECU, so that the security level of the provision data can be guaranteed in response to a request from the in-vehicle ECU. In this way, security processing can be performed on a data (message) basis in communication related to the request and provision related to the service so as to provide an appropriate security level. Furthermore, since processing according to the security level is performed on data used in communication related to the request and provision related to the service, pre-processing such as session establishment when performing communication related to the request and provision can be eliminated. In other words, for example, processing related to session establishment as pre-processing for ensuring security such as TLS (Transport Layer Security) can be eliminated, and communication overhead can be reduced.

In an in-vehicle device according to an aspect of the disclosure, a process of generating the provision data based on the security level includes at least one security process among a process of assigning a message authentication code, a process of assigning a digital signature, and a process of encryption a payload included in the provision data, and the controller varies the security process when generating the provision data according to the specified security level.

In this aspect, the process of generating provision data based on the security level includes one or more security processes. The security processes include at least one security process among a process of assigning a message authentication code, a process of assigning a digital signature, and a process of encryption a payload included in the provision data. As described above, since the security processes performed in the process of generating provision data include a plurality of types, it is possible to vary types or combinations of security processes included in the process of generating provision data, and to attempt a variety of security processes.

In an in-vehicle device according to an aspect of the disclosure, the controller increases a number of types of security processes included in the process of generating the provision data according to an increase in the security level.

In this aspect, the security level is defined in a plurality of levels, such as three stages (low: level 1<level 2<level 3: high). The controller of the in-vehicle device increases the number of types of security processes included in the process of generating provision data according to an increase in the security level, so that robustness against an invalid attack, etc. can be improved for messages of services requiring a high security level (sensor information, etc.). In addition, for messages of services requiring a relatively low security level (sensor information, etc.), the number of types of performed security processes can be reduced, thereby reducing the processing load in providing the service.

In an in-vehicle device according to an aspect of the disclosure, the controller specifies a security level by referring to a service table stored in an accessible storage area and including setting information related to a security level.

In this aspect, the controller of the in-vehicle device specifies a security level of a service requested by the in-vehicle ECU by referring to the service table stored in the accessible storage area. For example, in the service table stored in the storage area accessible from the controller of the in-vehicle device, such as a storage unit of the in-vehicle device, names (service names) of services that can be provided by the in-vehicle device are associated with security levels in a table format. By referring to the service table in which the service names are associated with the security levels in this way, the controller of the in-vehicle device can efficiently specify the security level of the requested service in accordance with the request data from the in-vehicle ECU.

In an in-vehicle device according to an aspect of the disclosure, the controller is configured to change the setting information related to the security level included in the service table when an attack affecting communication in the vehicle is carried out, and retransmit provision data generated based on the changed security level to the in-vehicle ECU.

In this aspect, for example, the controller of the in-vehicle device exhibits a function of an IDS (Intrusion Detection System), and detects an attack affecting communication in the vehicle, i.e., an invalid attack in the in-vehicle network. Alternatively, the controller of the in-vehicle device may acquire a message such as an alert indicating detection of invalid activity from another ECU having an invalid activity detection function such as an IDS. Alternatively, the controller may determine that an attack has been carried out on the vehicle when request data including a request to change the security level is received from an in-vehicle ECU transmitting the request data. When determining that an attack has been carried out on the vehicle through communication on the in-vehicle network in this manner, the controller of the in-vehicle device changes setting information related to the security level included in the service table, i.e., modifies the service table to raise the security level. The controller of the in-vehicle device generates provision data based on the changed security level to indicate that the security level has been changed, and retransmits the generated provision data to the in-vehicle ECU. In this way, the controller of the in-vehicle device dynamically changes (increases) the security level defined in the service table in response to an attack on the vehicle, generates provision data subjected to security processing in response to a higher security level, and provides (transmits) the provision data to the in-vehicle ECU. Therefore, it is possible to ensure an appropriate communication secure environment in response to a state of the attack on the vehicle while continuing to provide the service to the in-vehicle ECU (transmitting a message including sensor information, etc.).

In an in-vehicle device according to an aspect of the disclosure, the controller is configured to determine validity of the acquired request data, output provision data when a result of determining validity is positive, and output no provision data when the result of determining validity is negative.

In this aspect, the request data acquired from the in-vehicle ECU includes information that guarantees validity of a sender of the request data, such as a digital signature indicting the in-vehicle ECU that is the sender of the request data. The controller of the in-vehicle device determines validity of request data based on a digital signature, etc. included in the request data, outputs provision data to the in-vehicle ECU when a determination result is positive (valid), and outputs no provision data to the in-vehicle ECU when the determination result is negative (invalid). In this way, in communication related to the request and provision of the service, a determination process from a security perspective is performed on request data causing provision of the service, and when a determination result is negative, the provision data is not output. Thus, for example, it is possible to effectively prevent a service from being provided to an invalid in-vehicle ECU, etc.

In an in-vehicle device according to an aspect of the disclosure, the controller is configured to generate a session key when the result of determining validity is positive, and output provision data including the session key to the in-vehicle ECU.

In this aspect, when the result of determining validity for the request data acquired from the in-vehicle ECU is positive, for example, the controller of the in-vehicle device generates a session key consisting of a common key using a generated random number. The controller of the in-vehicle device outputs, to the in-vehicle ECU, provision data including the generated session key or to which the generated session key is assigned, and thereafter, outputs a message encrypted by the session key, i.e., a message in which encrypted sensor information, etc. is stored in the payload, to the in-vehicle ECU when providing a service (transmitting sensor information, etc. corresponding to the service). The in-vehicle ECU can receive provision of the service by decrypting the service message (encrypted sensor information, etc.) transmitted from the in-vehicle device afterwards using the session key included in the provision data acquired from the in-vehicle device. In this way, by encrypting the message using the generated session key each time communication related to the request and provision related to the service is executed, robustness of the message transmitted for provision of the service can be ensured.

In an in-vehicle device according to an aspect of the disclosure, request data from the in-vehicle ECU includes a public key corresponding to a private key held by the in-vehicle ECU, and the controller outputs provision data encrypted using the public key of the in-vehicle ECU to the in-vehicle ECU.

In this aspect, the request data from the in-vehicle ECU includes the public key corresponding to the private key held by the in-vehicle ECU. In this case, the request data from the in-vehicle ECU includes a public key certificate that certifies the in-vehicle ECU itself, and the public key may be included in the public key certificate (present in the public key certificate). The controller of the in-vehicle device encrypts the payload of the provision data using the public key included in the request data from the in-vehicle ECU, and outputs the encrypted provision data to the in-vehicle ECU. In this way, provision data responding to the request data is also encrypted, and since the encryption uses an asymmetric key based on the public key from the in-vehicle ECU, robustness of the provision data can be ensured.

In an in-vehicle device according to an aspect of the disclosure, a protocol for communication with the in-vehicle ECU is SOME/IP (Scalable service-oriented MiddlewarE over IP), request data corresponds to Find Service in SOME/IP, and provision data corresponds to Offer Service in SOME/IP.

In this aspect, the protocol for communication between the in-vehicle device and the in-vehicle ECU related to a request and provision of a service is SOME/IP (Scalable service-Oriented MiddlewarE over IP). In this case, the request data transmitted by the in-vehicle ECU corresponds to “Find Service” in SOME/IP, i.e., the in-vehicle ECU corresponds to a client in SOME/IP-SD (Service Discovery). The provision data transmitted by the in-vehicle device corresponds to “Offer Service” in SOME/IP, i.e., the in-vehicle device corresponds to a server in SOME/IP-SD (Service Discovery). In this way, when the in-vehicle device and the in-vehicle ECU communicate using the SOME/IP communication protocol, it becomes possible to apply security processing on a message basis to “Find Service” and “Offer Service” transmitted and received by the in-vehicle device and the in-vehicle ECU, thereby ensuring robustness of communication using SOME/IP.

In an in-vehicle device according to an aspect of the disclosure, the in-vehicle ECU and the in-vehicle device are configured as a single device, and communication between the in-vehicle ECU and the in-vehicle device corresponds to communication between applications in the in-vehicle device.

In this aspect, the in-vehicle ECU and the in-vehicle device are configured as a single device, and communication between the in-vehicle ECU and the in-vehicle device, i.e., communication related to a request and provision related to service is executed as communication between applications in the in-vehicle device (inter-process communication). In this way, through the in-vehicle network, robustness can be ensured not only for communication between different communication nodes but also for communication related to a request and provision of a service for a single in-vehicle device. In other words, when an in-vehicle device configured as a single device executes a plurality of applications, robustness in communication can be ensured even when inter-process communication related to a request and provision of a service is performed between these applications. Alternatively, for example, when a virtualization system such as a hypervisor is applied to an in-vehicle device and the in-vehicle device operates as a plurality of virtual environments (virtual machines) generated by the virtualization system, robustness can be ensured in communication related to a request and provision of a service between applications executed by the plurality of virtual machines, respectively.

An information processing method according to an aspect of the disclosure causes a computer communicatively connected to an in-vehicle ECU mounted in a vehicle to execute processing of acquiring request data related to a service request from the in-vehicle ECU, specifying a service provided to the in-vehicle ECU and a security level when providing the service based on the acquired request data, generating provision data for providing a service to the in-vehicle ECU based on the specified security level, and outputting the generated provision data to the in-vehicle ECU.

In this aspect, it is possible to provide an information processing method that causes a computer to function as an in-vehicle device capable of outputting provision data obtained by performing appropriate security processing on request data related to a service request when the request data is transmitted from the in-vehicle ECU.

An in-vehicle system according to an aspect of the disclosure is an in-vehicle system including an in-vehicle ECU mounted in a vehicle, and an in-vehicle device communicatively connected to the in-vehicle ECU, wherein the in-vehicle ECU is configured to generate request data related to a service request, and output the generated request data to the in-vehicle device, and the in-vehicle device is configured to acquire the request data from the in-vehicle ECU, specify a service provided to the in-vehicle ECU and a security level when providing the service based on the acquired request data, generate provision data for providing a service to the in-vehicle ECU based on the specified security level, and output the generated provision data to the in-vehicle ECU.

In this aspect, it is possible to provide an in-vehicle system including an in-vehicle device capable of outputting provision data obtained by performing appropriate security processing to request data related to a service request when the request data is transmitted from the in-vehicle ECU.

The disclosure will be specifically described based on the drawings illustrating the embodiments. An in-vehicle device 2 according to an embodiment of the disclosure will be described below with reference to the drawings. Note that the disclosure is not limited to these examples, is indicated by the claims, and is intended to include all modifications within the meaning and scope equivalent to the claims.

### Embodiment 1

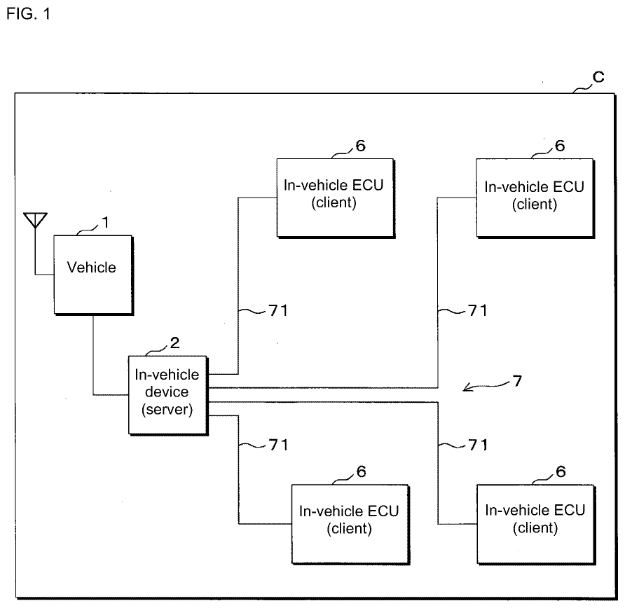

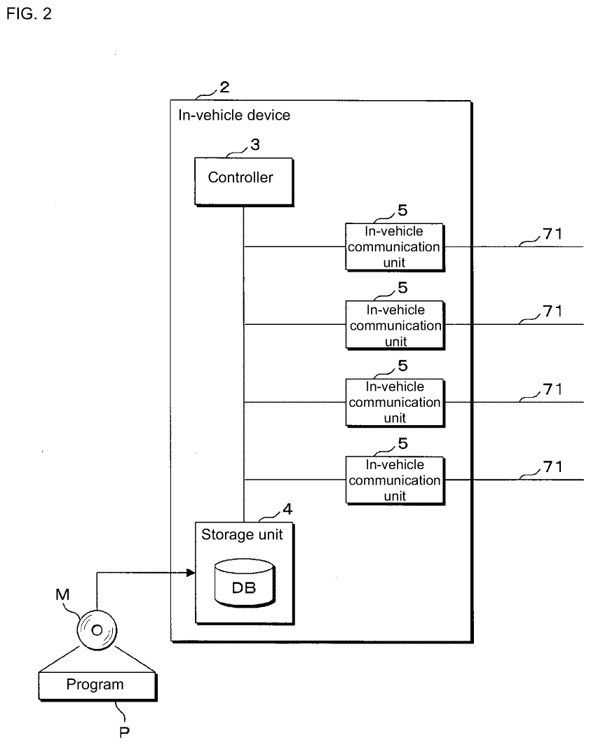

Hereinafter, an embodiment will be described with reference to the drawings. FIG. 1 is a schematic diagram illustrating a configuration of an in-vehicle system including the in-vehicle device 2 according to Embodiment 1. FIG. 2 is a block diagram illustrating a physical configuration of the in-vehicle device 2. The in-vehicle system S is configured with the in-vehicle device 2 mounted in a vehicle C as a main device, and the in-vehicle device 2 is communicatively connected to one or more in-vehicle ECUs 6 via an in-vehicle network. Furthermore, the in-vehicle device 2 may be communicatively connected to an external server or a mobile terminal such as a smartphone connected to an out-vehicle network such as the Internet via an out-vehicle communication device 1.

For example, the in-vehicle device 2 functions as a SOME/IP server, and the in-vehicle ECU 6 functions as a SOME/IP client. Although details will be described later, the in-vehicle device 2 and the in-vehicle ECU 6 transmit and receive messages (request data: Find Service, provision data: Offer Service) associated with provision of services from the in-vehicle device 2 using SOME/IP communication. Note that a communication protocol between the in-vehicle device 2 and the in-vehicle ECU 6 is not limited to SOME/IP, and may be used for other communication protocols that transmit and receive messages associated with service requests (request data similar to Find Service, etc.) and provision (provision data similar to Offer Service, etc.).

The in-vehicle device 2 functioning as a SOME/IP server may acquire (uplink) sensor information detected by various sensors, etc. connected to the in-vehicle device 2 and various sensors, etc. connected to each of a plurality of in-vehicle ECUs 6, and store the sensor information in a database (DB) stored in a storage unit 4, thereby centrally managing various pieces of sensor information, etc., which are instances of a service. The in-vehicle device 2 may further acquire various pieces of data, which are instances of a service, from an external server or a mobile terminal (smartphone), etc., via the out-vehicle communication device 1, and store the data in the database (DB). The in-vehicle device 2 may provide (downlink) the various sensor information, etc. centrally managed in the database (DB) in this way to the in-vehicle ECU 6 requesting the service by using SOME/IP communication.

The vehicle C is equipped with the out-vehicle communication device 1, the in-vehicle device 2, and the plurality of in-vehicle ECUs 6 for controlling various types of in-vehicle equipment (actuators and sensors). For example, the out-vehicle communication device 1 and the in-vehicle device 2 are communicatively connected by a harness such as a serial cable. The in-vehicle device 2 and the in-vehicle ECU 6 are communicatively connected by an in-vehicle network 7 compatible with a communication protocol such as Ethernet (registered trademark), and the in-vehicle device 2 may function as an Ethernet switch (layer 2 switch or layer 3 switch) having a relay function of IP packets.

The out-vehicle communication device 1 includes an out-vehicle communication unit (not illustrated) and an input/output I/F (not illustrated) (interface) for communicating with the in-vehicle device 2. The out-vehicle communication unit is a communication device for wireless communication using a mobile communication protocol such as LTE, 4G, 5G, or WiFi, and transmits and receives data to and from an external server or a mobile terminal via an antenna 11 connected to the out-vehicle communication unit. Communication between the out-vehicle communication device 1 and the external server is performed via an external network such as a public line network or the Internet.

The in-vehicle device 2 is an integrated ECU that functions as a SOME/IP server, includes, for example, a central control device such as a vehicle computer, and performs overall control of the vehicle C. The in-vehicle device 2 may further function as a relay device (GW) such as an Ether switch (layer 2 switch or layer 3 switch). The in-vehicle device 2 may be a PLB (Power Lan Box) functioning as a power distribution device that distributes and relays power output from a power supply device such as a secondary battery and supplies power to in-vehicle equipment such as an actuator connected to the ego vehicle (the in-vehicle device 2) in addition to relaying communication. Alternatively, the in-vehicle device 2 may be configured as one functional part of a body ECU that controls the entire vehicle C. Furthermore, the in-vehicle device 2 may function as an intrusion detection device such as an IDS (Intrusion Detection System).

The in-vehicle device 2 includes a controller 3, the storage unit 4, and an in-vehicle communication unit 5. The controller 3 includes a CPU (Central Processing Unit), an MPU (Micro Processing Unit), etc., and performs various control processes, calculation processes, etc. by reading and executing a control program P (program product) and data pre-stored in the storage unit 4.

The storage unit 4 includes a volatile memory element such as a RAM (Random Access Memory) or a nonvolatile memory element such as a ROM (Read Only Memory), an EEPROM (Electrically Erasable Programmable ROM) or a flash memory, and stores the control program P and data to be referenced during processing in advance. The control program P (program product) stored in the storage unit 4 may be a control program P (program product) read from a recording medium M readable by the in-vehicle device 2. Alternatively, the control program P may be downloaded from an external computer (not illustrated) connected to a communication network (not illustrated) and stored in the storage unit 4.

The storage unit 4 may store a database (DB) that stores and manages sensor information detected by various sensors, etc. connected to the in-vehicle device 2 and various sensors, etc. connected to each of the plurality of in-vehicle ECUs 6. The various sensor information, etc. stored in the database (DB) is provided as a service to each of the in-vehicle ECUs 6, which are SOME/IP clients, by using SOME/IP communication.

For example, the in-vehicle communication unit 5 is an input/output interface (Ethernet PHY unit) using a communication protocol such as Ethernet (TCP/IP). The in-vehicle communication unit 5 including the Ethernet PHY unit functions as a communication unit corresponding to a physical layer for communication between the in-vehicle device 2 and the in-vehicle ECU 6.

A plurality of in-vehicle communication units 5 is provided, and each communication line 71 (Ethernet cable) included in the in-vehicle network 7 is connected to each in-vehicle communication unit 5. By providing the plurality of in-vehicle communication units 5 in this manner, the in-vehicle network 7 may be divided into a plurality of segments, and the in-vehicle ECU 6 may be connected to each segment according to the function of the in-vehicle ECU 6. The controller 3 of the in-vehicle device 2 communicates with the in-vehicle ECU 6 connected to the in-vehicle network 7 via the in-vehicle communication unit 5.

The in-vehicle ECU 6 functions as a SOME/IP client, and includes a controller, a storage unit, and an in-vehicle communication unit similarly to the in-vehicle device 2. For example, the in-vehicle ECU 6 may be connected to various sensors such as a LiDAR (Light Detection and Ranging), a human sensor, a CMOS camera, and an infrared sensor, and transmit various sensor information acquired from these various sensors to the in-vehicle device 2. The in-vehicle ECU 6 may be further connected to actuators such as various switches, a car air conditioner, a lamp device, and a power train device such as an engine or a drive motor, and may be configured as an individual ECU that controls these actuators. The in-vehicle ECU 6 may further function as an intrusion detection device such as an IDS (Intrusion Detection System).

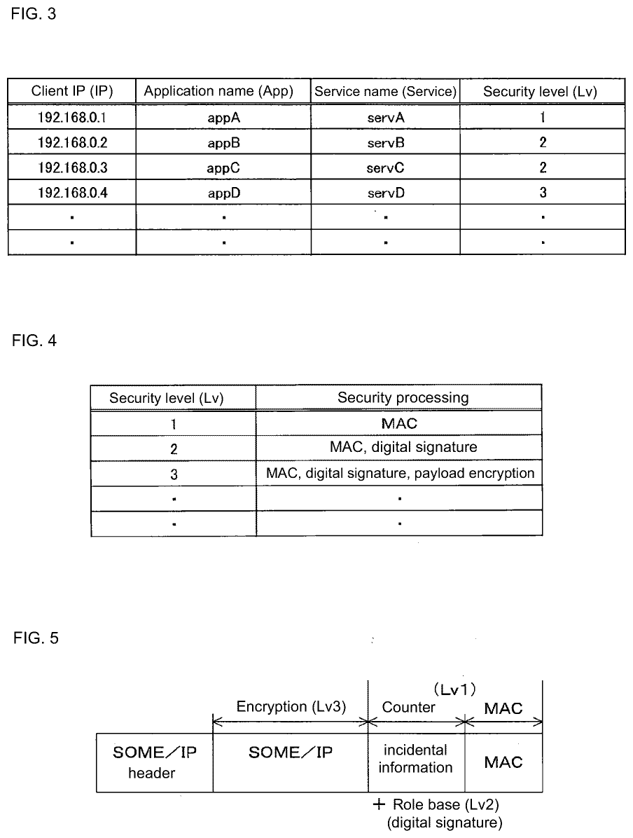

FIG. 3 is an explanatory diagram illustrating an example of a service table. FIG. 4 is an explanatory diagram illustrating an example of a security processing table. In a storage area allowed to be accessed by the controller 3 of the in-vehicle device 2, such as the storage unit 4 of the in-vehicle device 2, setting information on security levels for services (service table) and information on security processing corresponding to the security levels (security processing table) are stored, for example, in table format.

The service table includes, as management items (fields), for example, a client IP, an application name, a service name, and a security level. For example, an IP address of the in-vehicle ECU 6, which is a client of SOME/IP, is stored in the management item of the client IP. Alternatively, a media access control address (MAC) may be stored instead of the IP address. When request data is acquired, the controller 3 of the in-vehicle device 2 may determine validity of the request data by comparing a transmission address of the request data with an IP address previously defined in a management item of the client IP in the service table.

The management item of the application name stores, for example, a name of an application executed by the in-vehicle ECU 6 which is a client of SOME/IP, where the name of the application corresponds to a service requested by the in-vehicle ECU 6. When request data is acquired, the controller 3 of the in-vehicle device 2 may determine validity of the request data by comparing an application name included in the request data with an application name defined in advance in the management item of the application name in the service table.

The management item of the service name stores a name of a service (a name of a service instance) corresponding to an application name stored in the same record. A service defined (stored) in the management item of the service name corresponds to a service requested and provided based on SOME/IP-SD (Service Discovery).

The management item of the security level stores a security level value corresponding to a service name stored in the same record. In the present embodiment, the security level value is indicated by a number, and a security level is set to increase as the value increases (low: level 1<level 2<level 3 . . . <level N: high). The security level may be set to three levels, for example, or the security level may be set by being further divided into four or more levels (four or more stages).

Request data (Find Service) transmitted from the in-vehicle ECU 6 functioning as a SOME/IP client includes an application name (AppA) executed by the in-vehicle ECU 6. The in-vehicle device 2 functioning as a SOME/IP server can specify the corresponding service name by referring to the service table based on the application name (AppA) included in the request data (Find Service) acquired from the in-vehicle ECU 6. Alternatively, the request data (Find Service) from the in-vehicle ECU 6 may include a service name (service), and the in-vehicle device 2 may specify a service to be provided in response to the request data.

The security processing table includes, for example, security level and security processing as management items (fields). The management item of the security level stores a security level value defined in the management item of the security level in the service table. Therefore, the security processing table and the service table are normalized by the management item of the security level.

The management item of the security processing stores processing content of security processing corresponding to a security level value stored in the same record. For example, when the security level is set to three levels (low: level 1<level 2<level 3: high), if the security level is the lowest level 1, the security processing assigns a message authentication code (MAC) to a message related to SOME/IP. Alternatively, the security processing may further assign a counter to a message related to SOME/IP. By assigning a MAC, it is possible to verify whether the message has been tampered with or replaced midway (message integrity). In this way, it is possible to address message tampering or replay attacks.

When the security level is level 2, which is intermediate, the security processing assigns a digital signature indicating the in-vehicle device 2 itself to a message related to SOME/IP instead of assigning the MAC (instead of the MAC). Alternatively, the security processing may assign a digital signature indicating the in-vehicle device 2 itself to a message related to SOME/IP in addition to assigning a MAC. Alternatively, the security processing may further assign a role base to a message related to SOME/IP. By assigning a digital signature, it is possible to prove that a message (information) transmitted by the in-vehicle device 2 with regard to SOME/IP is that of the in-vehicle device 2 (principal) who signed the message (a message transmitted from a legitimate sender) and that the message has not been tampered with. In this way, it is possible to address attacks impersonating a sender of a message and attacks related to a role base.

When the security level is level 3, which is the highest level, the security processing includes a process of encrypting the payload (such as sensor information stored in the payload) in the message related to SOME/IP in addition to adding a digital signature assigned in place of the MAC (instead of the MAC). Alternatively, the security processing may include a process of encrypting the payload (such as sensor information stored in the payload) in the message related to SOME/IP in addition to assigning a MAC and a digital signature. When performing a process of encrypting the payload, the controller 3 of the in-vehicle device 2 may generate a session key, include the generated session key in provision data (Offer Service), and output the session key to the in-vehicle ECU 6. In this way, it is possible to address message eavesdropping attacks. Instances of services set to such a high security level include, for example, GPS information, copyright information of an infotainment system, and information of a mobile terminal such as a smartphone, etc., and this information can be efficiently protected.

FIG. 5 is an explanatory diagram illustrating a protected SOME/IP message. SOME/IP (Scalable service-Oriented MiddlewarE over IP) is service-oriented middleware used to control messages transmitted and received in the in-vehicle network 7, and is defined as a protocol of a layer higher than layer 4 (TCP/UDP, etc.) in OSI (Open System Interconnection). The SOME/IP message includes a header area including a source address and a destination address, etc., and a payload area for storing data corresponding to a provided service such as sensor information. Furthermore, the SOME/IP message includes incidental information including a count, a role base (digital signature), etc., and a message authentication code (MAC) by being protected according to the security level according to the present embodiment. The incidental information and the MAC may be stored in the payload area.

As described above, protection for the SOME/IP message is provided according to the security level. For example, an MAC (and count) is assigned at level 1, a role base (digital signature) is assigned at level 2, and payload encryption (encryption with a session key) is further performed at level 3. In this way, by increasing types of provided security processing with respect to the SOME/IP message according to the security level of the service corresponding to the message, it is possible to vary protection modes for the SOME/IP message.

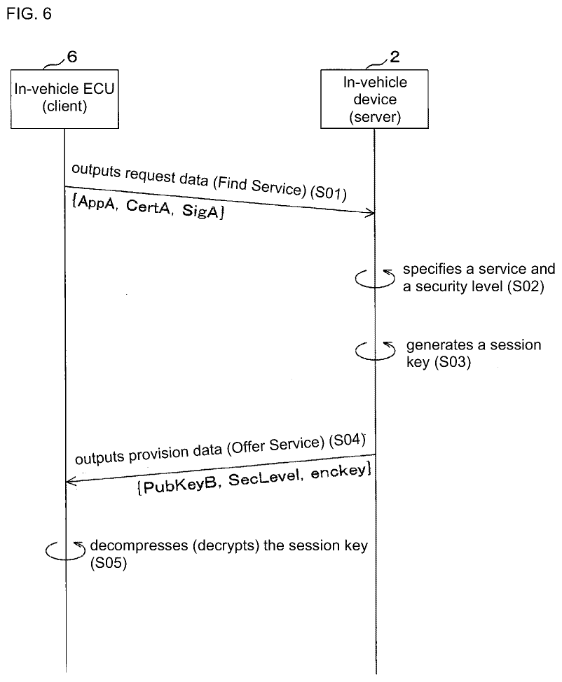

FIG. 6 is an explanatory diagram illustrating a processing sequence between the in-vehicle device 2 (server) and the in-vehicle ECU 6 (client). In the present embodiment, the in-vehicle device 2 functions as a server of SOME/IP-SD (Service Discovery), and the in-vehicle ECU 6 functions as a client.

The in-vehicle device 2 and the in-vehicle ECU 6 each hold (store) a public key certificate, and the in-vehicle device 2 and the in-vehicle ECU 6 may realize mutual authentication. In addition, the in-vehicle device 2 and the in-vehicle ECU 6 may realize an authentication protocol by assigning information according to a security level to a payload in request data (Find Service) and provision data (Offer Service) based on the SOME/IP protocol. The in-vehicle device 2 and the in-vehicle ECU 6 may perform security processing according to a security level on data of a subscribe request (Subscribe Eventgroup, Subscribe Event ACK), etc. made after transmitting and receiving request data (Find Service) and provision data (Offer Service).

The in-vehicle ECU 6 outputs (transmits) request data (Find Service) to the in-vehicle device 2 (S01). The in-vehicle ECU 6 generates request data including an application (AppA) corresponding to a service (using a service) requested to be provided. The in-vehicle ECU 6 may further generate request data including a public key certificate (CertA) of the in-vehicle ECU 6 and a digital signature (SigA) based on a private key of the in-vehicle ECU 6 in the request data. The in-vehicle ECU 6 outputs (transmits) the request data generated in this way to the in-vehicle device 2.

The in-vehicle device 2 specifies a service and a security level based on the request data acquired from the in-vehicle ECU 6 (S02). The in-vehicle device 2 acquires the request data from the in-vehicle ECU 6 and verifies the digital signature (SigA) included in the request data to determine validity of the request data, i.e., whether or not a sender of the request data is the real in-vehicle ECU 6. When a result of the determination is a negative result, the in-vehicle device 2 may not respond to the request data, i.e., may not transmit provision data. In addition, the request data, etc. may be encrypted by AEAD (Authentic Encryption with Associated Data) using a pre-shared key, and may be transferred with a MAC attached. By using the AEAD, encryption and authentication are simultaneously performed, and confidentiality, integrity, and authenticity of the request data, etc. can be ensured at the same time.

When the result of the determination is a positive result, i.e., when it is determined that the sender of the request data is the real in-vehicle ECU 6, the in-vehicle device 2 specifies a name of the service requested by an application receiving the service and a security level when providing the service, from a name of the application (AppA) included in the request data or content of the public key certificate (CertA) included in the request data. When specifying the service and the security level, the in-vehicle device 2 may refer to the service table stored in the storage unit 4. In this instance, when there is a problem such as a mismatch between various content defined in the service table and content based on the request data from the in-vehicle ECU 6, the in-vehicle device 2 may not respond to the request data, i.e., may not transmit provision data.

The in-vehicle device 2 generates a session key (S03). When the in-vehicle device 2 determines (judges) that the request data from the in-vehicle ECU 6 is valid based on these determination results, etc., the in-vehicle device 2 generates a session key (common key: enckey) using any or known means.

The in-vehicle device 2 outputs (transmits) provision data (Offer Service) including the generated session key to the in-vehicle ECU 6 (S04). The in-vehicle device 2 generates provision data (Offer Service) (stored in a payload) including the generated session key (enckey), the public key certificate of the in-vehicle device 2 (PubkeyB), and the specified security level (SecLevel), and outputs (transmits) the provision data to the in-vehicle ECU 6. In this instance, the in-vehicle device 2 may encrypt a payload of the generated provision data using a public key present in the public key certificate (CertA) included in the request data from the in-vehicle ECU 6, and output (transmit) the encrypted provision data to the in-vehicle ECU 6. This procedure ensures that only the corresponding owner of the private key (communication node) can decrypt the data, and confidentiality of the session key is ensured.

The in-vehicle ECU 6 acquires the provision data and decompresses (decrypts) the session key (enckey) included in the provision data (S05). The in-vehicle ECU 6 acquires the encrypted provision data from the in-vehicle device 2 and decrypts the payload of the encrypted provision data using a private key corresponding to the public key certificate (CertA) of the in-vehicle ECU 6. The in-vehicle ECU 6 verifies validity of a public key certificate (PubkeyB) of the in-vehicle device 2 included in the provision data, and when it is determined that the public key certificate (PubkeyB) is valid, the in-vehicle ECU 6 acquires the session key (enckey) and the security level (SecLevel) included in the provision data. By acquiring the session key (enckey) and the security level (SecLevel), the in-vehicle ECU 6 recognizes the security level of the provided service and can subsequently decrypt a message whose payload is encrypted using the session key. In addition, the pre-shared key may be updated using this session key.

In SOME/IP communication between the in-vehicle device 2 and the in-vehicle ECU 6, after the request data (Find Service) and the provision data (Offer Service) are transmitted and received, security processing according to the security level may be performed on subscribe request data, etc. (Subscribe Event group and Subscribe Event ACK). After transmitting the ACK to the in-vehicle ECU 6, the in-vehicle device 2 performs security processing according to the security level on a message (Event/Field Notification) including data of the provided service (sensor information, etc.), and then transmits the message to the in-vehicle ECU 6. As described above, for example, the message (Event/Field Notification) from the in-vehicle device 2 is subjected to various types of security processing according to the security level, such as encryption of a payload using a session key, and assignment of a MAC and a digital signature.

A mode of security processing described in the present embodiment assumes a relatively high security level (for example, level 3), but is not limited thereto. When the security level is relatively low (for example, levels 1 and 2), the in-vehicle device 2 may generate and output provision data subjected to security processing such as assignment of a MAC and a digital signature, without generating the session key (enckey). In this case, the payload of the message (Event/Field Notification) transmitted by the in-vehicle device 2 according to the provided service may be in plain text without encryption, and only security processing such as assignment of a MAC and a digital signature may be performed.

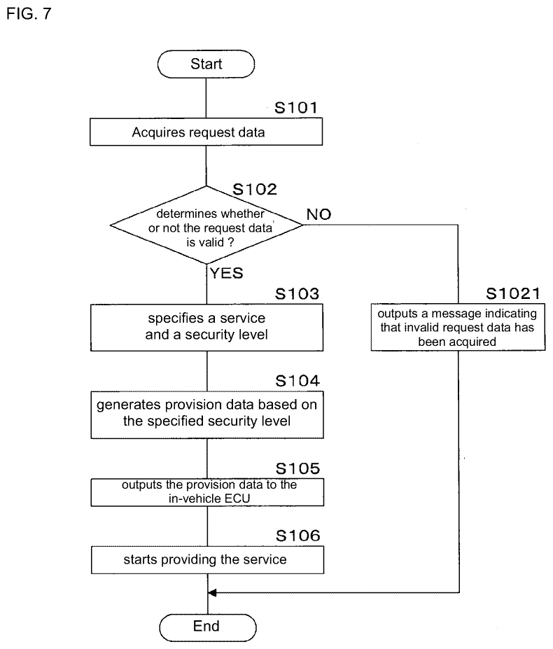

FIG. 7 is a flowchart illustrating processing of the controller 3 of the in-vehicle device 2. For example, the controller 3 of the in-vehicle device 2 steadily performs the following processing when the vehicle C is in a started state or a stopped state (an IG switch or a power switch is turned on or off).

The controller 3 of the in-vehicle device 2 acquires request data with regard to a service request from the in-vehicle ECU 6 (S101). The in-vehicle ECU 6 functioning as a client of SOME/IP transmits the request data (Find Service) to the in-vehicle device 2 functioning as a server of SOME/IP. The in-vehicle ECU 6 may include, in the request data, the application name (AppA) corresponding to the service, the public key certificate (CertA) of the in-vehicle ECU 6, and the digital signature (SigA) based on the private key of the in-vehicle ECU 6.

The controller 3 of the in-vehicle device 2 determines whether or not the request data is valid (S102). The controller 3 of the in-vehicle device 2 determines validity of the request data, i.e., whether or not the request data is valid, for example, by verifying the digital signature (SigA) included in the request data.

When it is determined that the request data is not valid (S102: NO), i.e., when it is determined that the request data is invalid, the controller 3 of the in-vehicle device 2 outputs a message indicating that invalid request data has been acquired (S1021). When it is determined that the request data is not valid, i.e., the request data is invalid, the controller 3 of the in-vehicle device 2 stores, in the storage unit 4, a message indicating that in valid request data has been acquired in association with a time of reception of the valid request data. When storing the invalid request data in the storage unit 4 in association with the time of reception thereof, the controller 3 of the in-vehicle device 2 may store information about the invalid request data in an abnormality history database stored in the storage unit 4. The controller 3 of the in-vehicle device 2 may display information indicating that the invalid request data has been acquired on an HMI (Human Machine Interface) device or transmit the information to an external server via the out-vehicle communication device 1.

When it is determined that the request data is valid (S102: YES), the controller 3 of the in-vehicle device 2 specifies a service and a security level to be provided to the in-vehicle ECU 6 (S103). Based on a name of an application included in the request data, the controller 3 of the in-vehicle device 2 specifies a service corresponding to the application and a security level when providing the service by referring to the service table.

The controller 3 of the in-vehicle device 2 generates provision data based on the specified security level (S104). For example, when the security level is set to three levels (low: level 1<level 2<level 3: high), the controller 3 of the in-vehicle device 2 generates provision data subjected to security processing according to the specified security level.

The controller 3 of the in-vehicle device 2 may determine security processing according to the security level, for example, by referring to the security processing table stored in the storage unit 4. For example, when the security level is level 1, which is the lowest level, the controller 3 of the in-vehicle device 2 generates provision data to which a MAC generated using a private key shared with the in-vehicle ECU 6 is assigned. When the security level is level 2, which is intermediate, the controller 3 of the in-vehicle device 2 generates provision data to which a digital signature identifying the in-vehicle device 2 itself is further assigned in addition to assigning the MAC.

When the security level is level 3, which is the highest level, the controller 3 of the in-vehicle device 2 generates provision data encrypted using a public key from the in-vehicle ECU 6 in addition to assigning a MAC and a digital signature. In this instance, the controller 3 of the in-vehicle device 2 may generate the provision data by further including a session key. The session key may be used as a common key by the in-vehicle device 2 and the in-vehicle ECU 6 when encrypting data that is transmitted when providing a service. In other words, the payload of the message transmitted when providing the service may be encrypted by the controller 3 of the in-vehicle device 2 using the session key. In this case, the in-vehicle ECU 6 decrypts the payload of the message transmitted in response to provision of the service from the in-vehicle device 2 using the session key.

In this way, for example, the controller 3 of the in-vehicle device 2 generates provision data (Offer Service) including the generated session key (enckey), the public key certificate (PubkeyB) of the in-vehicle device 2, and the specified security level (SecLevel) (stored in the payload) according to the security level. The controller 3 of the in-vehicle device 2 may further encrypt the payload of the provision data (Offer Service) using the public key (present in the public key certificate) included in the request data from the in-vehicle ECU 6.

In this way, the controller 3 of the in-vehicle device 2 may increase types of security processing used when generating provision data in accordance with an increase in the security level, i.e., as the security level becomes higher. Alternatively, the controller 3 of the in-vehicle device 2 may increase the number of digits of a random number used when generating a MAC in accordance with an increase in the security level, thereby improving difficulty of decrypting a security object such as a MAC.

The controller 3 of the in-vehicle device 2 outputs the provision data generated according to the security level to the in-vehicle ECU 6 (S105). The controller 3 of the in-vehicle device 2 outputs the provision data (Offer Service) generated and encrypted according to the security level to the in-vehicle ECU 6.

The controller 3 of the in-vehicle device 2 starts providing the service according to the security level (S106). The controller 3 of the in-vehicle device 2 encrypts a message (Event/Field Notification) associated with provision of the service using a session key according to the security level and transmits the message to the in-vehicle ECU 6. Alternatively, when the security level is relatively low, the controller 3 may set the payload as plain text without encrypting the payload and transmit a message (Event/Field Notification) to which a MAC and a digital signature are assigned to the in-vehicle ECU 6. After executing processing of S106 or S1021, the controller 3 of the in-vehicle device 2 ends a series of processes in this flow. Alternatively, the controller 3 of the in-vehicle device 2 may perform a loop process to execute processing from S101 again after executing processing of S106 or S1021.

When providing a plurality of services, the controller 3 of the in-vehicle device 2 may generate a process for each of the services and perform processing related to provision of the plurality of services in parallel by a plurality of processes. When performing parallel processing by the plurality of processes according to the number of services to be provided, the controller 3 of the in-vehicle device 2 may change the quantity of resources allocated to the processes executing the services according to security levels of the services. In other words, it is possible to set (allocate) more hardware resources, such as CPU allocation time, memory occupation amount, or the number of threads, for a process for providing a service having a high security level than for a process for providing a service having a low security level. In this way, it is possible to execute a process related to a service having a high security level with a comparatively higher priority.

### Embodiment 2

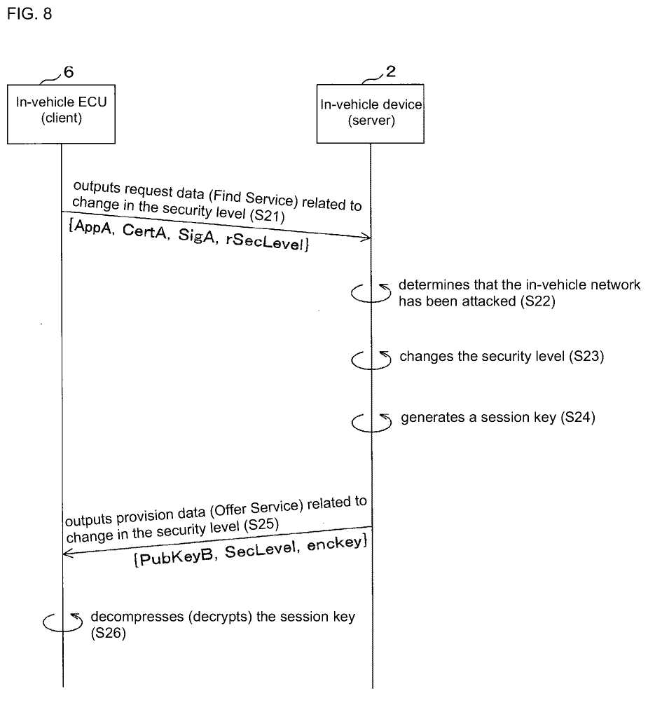

FIG. 8 is an explanatory diagram illustrating a processing sequence between the in-vehicle device 2 (server) and the in-vehicle ECU 6 (client) related to Embodiment 2 (dynamic change of a security level). The in-vehicle device 2 and in-vehicle ECU 6 of Embodiment 2 show processing (sequence) related to an event in which a security level of a service provided in Embodiment 1 is changed after a message (Event/Field Notification) corresponding to the service is transmitted from the in-vehicle device 2 to the in-vehicle ECU 6 periodically, regularly, or steadily.

The in-vehicle ECU 6 outputs (transmits) request data (Find Service) related to change in the security level to the in-vehicle device 2 (S21). For example, when detecting an attack on itself or an attack on an in-vehicle network 7, the in-vehicle ECU 6 generates request data related to change in the security level and outputs (transmits) the request data to the in-vehicle device 2. The in-vehicle ECU 6 generates request data including an application (AppA), a public key certificate (CertA) of the in-vehicle ECU 6, and a digital signature (SigA) based on a private key of the in-vehicle ECU 6 similarly to the request data of Embodiment 1, and further including a request for changing (increasing) the security level (a value of the security level after change: rSecLevel). The in-vehicle ECU 6 outputs (transmits) the request data including the value of the security level after change (rSecLevel) to the in-vehicle device 2.

The in-vehicle device 2 determines that the in-vehicle network 7 has been attacked (S22). When acquiring request data related to change in the security level from the in-vehicle ECU 6, the in-vehicle device 2 determines that the in-vehicle network 7 has been attacked. Alternatively, even when the in-vehicle device 2 does not acquire request data related to change in the security level from the in-vehicle ECU 6, for example, the in-vehicle device 2 may determine that the in-vehicle network 7 has been attacked by exerting a function of an IDS, etc. and detecting an attack that affects communication in the vehicle C, i.e., an invalid attack on the in-vehicle network 7.

The in-vehicle device 2 changes the security level (S23). The in-vehicle device 2 changes the security level of the service defined in the service table based on an application name (AppA) and a security level value (rSecLevel) included in the request data acquired from the in-vehicle ECU 6. By changing the security level, the security level of the target service is set to a higher security level than a security level before the attack is detected.

The in-vehicle device 2 generates a session key (S24). The in-vehicle device 2 generates (regenerates) the session key again similarly to process S03 of Embodiment 1. By regenerating the session key in this manner, it is possible to make the session key used in SOME/IP communication between the in-vehicle device 2 and the in-vehicle ECU 6 different between before and after the attack is detected.

The in-vehicle device 2 outputs (transmits) provision data (Offer Service) related to change in the security level to the in-vehicle ECU 6 (S25). Similarly to S04 of Embodiment 1, the in-vehicle device 2 generates provision data (Offer Service) including a regenerated session key (enckey), a public key certificate (PubkeyB) of the in-vehicle device 2, and a security level (SecLevel) after change (stored in a payload), and outputs (transmits) the provision data to the in-vehicle ECU 6.

The in-vehicle ECU 6 acquires the retransmitted provision data and decompresses (decrypts) the session key (enckey) included in the provision data (S26). The in-vehicle ECU 6 decrypts the provision data acquired similarly to Embodiment 1, using the private key, thereby decompressing (decrypting) the session key (enckey) included in the provision data. The session key (enckey) is a session key regenerated with detection of an attack as a trigger. The in-vehicle ECU 6 can recognize the changed security level by referring to the security level (SecLevel) included in the provision data. The in-vehicle ECU 6 can recognize the changed security level, continue to receive the service provided by the in-vehicle device 2 using the session key retransmitted from the in-vehicle device 2 even after detecting the attack, and execute an application using the message (Event/Field Notification) transmitted in association with provision of the service.

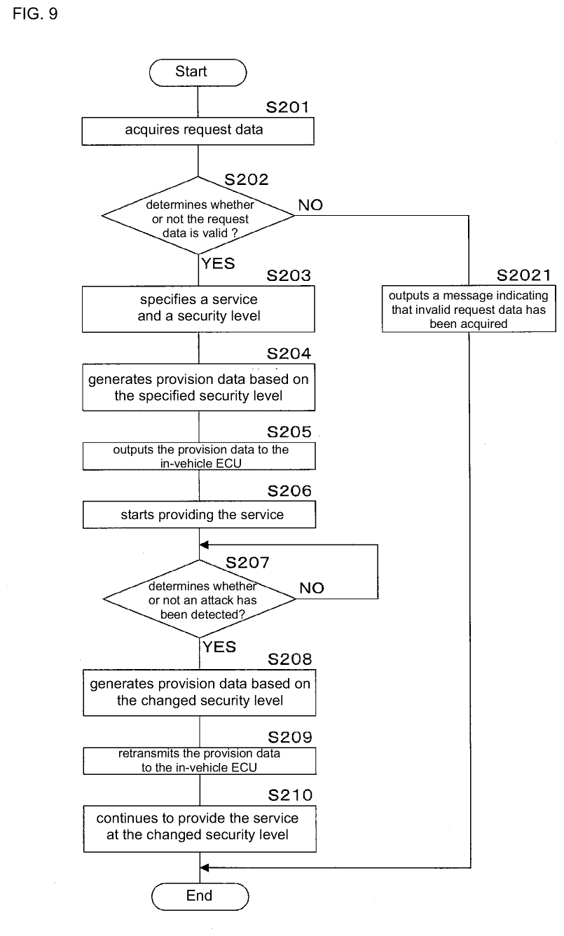

FIG. 9 is a flowchart illustrating processing of the controller 3 of the in-vehicle device 2. For example, the controller 3 of the in-vehicle device 2 steadily performs the following processing when the vehicle C is in a started state or a stopped state (an IG switch or a power switch is turned on or off).

The controller 3 of the in-vehicle device 2 performs processing from S201 to S206 similarly to processing from S101 to S106 of Embodiment 1. By performing this processing, the controller 3 of the in-vehicle device 2 is in a state of starting to provide a service according to the security level, similarly to Embodiment 1, i.e., continuously transmitting (outputting) a message associated with provision of the service (a message having sensor information, etc. corresponding to the service stored in the payload) to the in-vehicle ECU 6, which is a client.

The controller 3 of the in-vehicle device 2 determines whether or not an attack has been detected (S207). For example, the controller 3 of the in-vehicle device 2 determines that an attack has been detected when acquiring a notification from the in-vehicle ECU 6 that there is an attack, or when detecting an attack that affects communication in the vehicle C, i.e., an invalid attack in the in-vehicle network 7, by an IDS function of the in-vehicle device 2. The notification from the in-vehicle ECU 6 that there is an attack may be based on, for example, request data (Find Service) from the in-vehicle ECU 6 for requesting change in the security level of the service currently being provided. In this case, the controller 3 of the in-vehicle device 2 may determine that an invalid attack has been detected in the in-vehicle network 7 when acquiring request data (Find Service) for requesting change in the security level from the in-vehicle ECU 6. When it is determined that an attack has not been detected (S207: NO), the controller 3 of the in-vehicle device 2 performs loop processing to execute processing of S207 again.

When it is determined that an attack has been detected (S207: YES), the controller 3 of the in-vehicle device 2 generates provision data based on the changed security level (S208). When it is determined that an attack has been detected, the controller 3 of the in-vehicle device 2 changes the security level of the service currently being provided based on the request data (Find Service) from the in-vehicle ECU 6, and generates provision data based on the changed security level.

For example, the controller 3 of the in-vehicle device 2 refers to the service table stored in the storage unit 4 to specify a current security level of the service. Then, the controller 3 of the in-vehicle device 2 changes the service table based on the changed security level value (rSecLevel) included in the request data from the in-vehicle ECU 6. In this way, it is possible to set the service table so that the target service (the service currently being provided) has a higher security level than the current security level. For example, when the current security level of the target service is 1, the controller 3 of the in-vehicle device 2 changes the security level to 2. When the current security level of the target service is 2, the controller 3 of the in-vehicle device 2 changes the security level to 3. When the current security level of the target service is the highest value (for example, 3, etc.), the controller 3 of the in-vehicle device 2 may maintain the security level at the highest value.

The controller 3 of the in-vehicle device 2 may vary a degree of increase in the security level depending on the impact (severity) of the detected attack. For example, when the in-vehicle device 2 has an IDS (Intrusion Detection System) function, the impact of the detected attack is derived using the IDS function. For example, when the impact on control, etc. of the vehicle C is high, the security level may be increased by two steps, and when the impact is low, the security level may be increased by one step. When the security level is increased, the overhead in SOME/IP communication also increases. However, by increasing (changing) the security level in consideration of the degree of impact of the attack on control, etc. of the vehicle C, it is possible to inhibit excessive occurrence of the overhead.

When detecting an invalid attack in the in-vehicle network 7 in this manner, the controller 3 of the in-vehicle device 2 may store, in the storage unit 4 (save in an abnormality history database), information indicating that an attack has been detected in association with a time of detection of the attack similarly to S1021 of Embodiment 1. The controller 3 of the in-vehicle device 2 may further output the information indicating that the attack has been detected to an HMI (Human Machine Interface) device, or transmit the information to an external server via the out-vehicle communication device 1.

The controller 3 of the in-vehicle device 2 retransmits the provision data to the in-vehicle ECU 6 (S209). The controller 3 of the in-vehicle device 2 generates (regenerates) provision data indicating that the security level has been changed, and retransmits the regenerated provision data to the in-vehicle ECU 6. The controller 3 of the in-vehicle device 2 may include, for example, a value of the changed security level, a public key certificate identifying the controller 3 itself, and a session key in the provision data. In this instance, the controller 3 of the in-vehicle device 2 may generate (regenerate) the session key again, and retransmit the provision data indicating that the security level has been changed, including the regenerated session key, to the in-vehicle ECU 6.

The session key is used to encrypt and decrypt data (service instance such as sensor information) included in a payload of a message when the in-vehicle device 2, which is a server, transmits a message to the in-vehicle ECU 6, which is a client, in association with provision of the service after retransmission of the provision data. Therefore, by varying the session key used in SOME/IP communication between the in-vehicle device 2 and the in-vehicle ECU 6 in response to detection of an attack, i.e., before and after detection of an attack, it is possible to ensure robustness of a message transmitted for provision of the service.

The controller 3 of the in-vehicle device 2 continues to provide the service at the changed security level (S210). The controller 3 of the in-vehicle device 2 refers to the service table having the changed security level, i.e., in which the security level of the target service has been changed, generates a message associated with provision of the service according to the changed security level, and transmits the message to the in-vehicle ECU 6. In this way, even when an attack is made on the in-vehicle network 7, the controller 3 of the in-vehicle device 2 can continue to provide the service to the in-vehicle ECU 6 while ensuring robustness against the attack.

### Embodiment 3

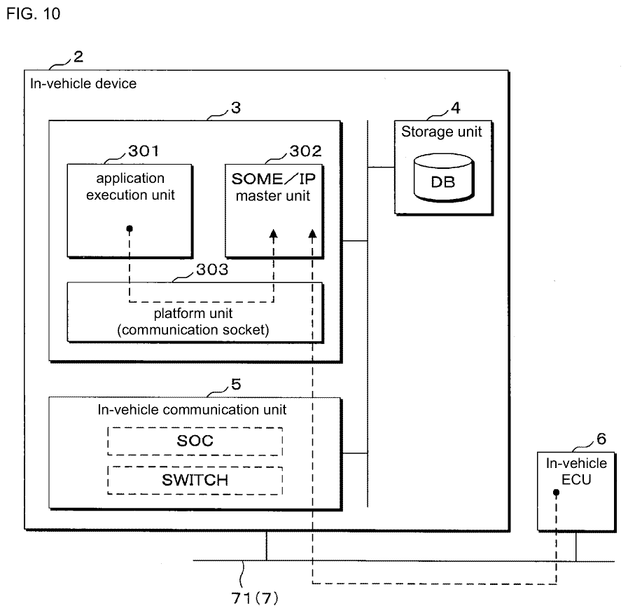

FIG. 10 is a functional block diagram illustrating functional units included in a controller 3 of an in-vehicle device 2 related to Embodiment 3 (inter-process communication in the in-vehicle device 2). In the present embodiment, the in-vehicle device 2 (SOME/IP server) and the in-vehicle ECU 6 (SOME/IP client) in Embodiment 1 are configured as a single device, that is, the in-vehicle device 2 has functions of both a SOME/IP server and a SOME/IP client and is responsible for processes of both of the SOME/IP server and the SOME/IP client.

The controller 3 of the in-vehicle device 2 executes control programs stored in the storage unit 4 to function as an application execution unit 301, a SOME/IP master unit 302, and a platform unit 303. That is, the control programs stored in the storage unit 4 include an application program that uses a service, a communication program based on the SOME/IP protocol, and the platform unit 303 including a communication socket module, a software library, etc.

The application execution unit 301 executes an application program that uses a service to perform various control processes or information processes using sensor information, camera images, etc., which are instances of the service. The SOME/IP master unit 302 performs overall control related to SOME/IP communication. Furthermore, the SOME/IP master unit 302 may acquire sensor information detected by various sensors, etc. connected to the in-vehicle device 2 and various sensors, etc. connected to each of a plurality of in-vehicle ECUs 6 connected to the in-vehicle network 7, and store the sensor information in a database (DB) stored in the storage unit 4. The SOME/IP master unit 302 may provide various sensor information, etc. centrally stored in the database as service instances to the application execution unit 301 using SOME/IP communication. The platform unit 303 performs overall control of inter-process communication between the application execution unit 301 and the SOME/IP master unit 302, that is, a protocol in a layer lower than a layer of SOME/IP communication.

The application execution unit 301 corresponds to a SOME/IP client, and the SOME/IP master unit 302 corresponds to a SOME/IP server. Communication between the application execution unit 301 and the SOME/IP master unit 302 is executed as IP communication in the in-vehicle device 2, for example, using a loopback address. Therefore, the application execution unit 301 functioning as the SOME/IP client and the SOME/IP master unit 302 functioning as the SOME/IP server can perform SOME/IP communication with security processing applied according to the security level, i.e., transmit and receive protected SOME/IP messages, similarly to the in-vehicle device 2 and in-vehicle ECU 6 of Embodiments 1 and 2. In this way, security processing related to SOME/IP communication shown in Embodiments 1 and 2 can be applied to the in-vehicle device 2, which is a single device (communication node), thereby expanding availability of the security processing.

A mode in which security processing related to SOME/IP communication is applied to the in-vehicle device 2, which is a single device (communication node), is not limited to a case in which hardware resources are directly controlled by an OS (operating system), etc. Security processing related to SOME/IP communication according to the present embodiment may be applied to SOME/IP communication between a plurality of virtual environments (virtual machines) generated by a virtualization system such as a Hypervisor. That is, one of the plurality of virtual machines may function as a SOME/IP server, and other virtual machine may function as SOME/IP clients. In this way, by applying security processing related to SOME/IP communication illustrated in Embodiments 1 and 2 to the virtual environment (virtual machine), availability of security processing can be increased.

The embodiments disclosed herein are illustrative in all respects and should not be considered as restrictive. The scope of the present invention is defined by the claims, not by the above meaning, and is intended to include all modifications within the scope and meaning equivalent to the claims.

A plurality of claims set forth in the claims can be combined with each other regardless of the form of reference. The claims may include a multiple dependent claim depending on a plurality of claims. A multiple dependent claim may be dependent on another multiple dependent claim. When a multiple dependent claim dependent on another multiple dependent claim is not presented, this does not limit presentation of the multiple dependent claim dependent on the multiple dependent claim.

1-12. (canceled)

13. An in-vehicle device communicatively connected to an in-vehicle ECU mounted in a vehicle, the in-vehicle device comprising:
a controller configured to perform processing related to a service request from the in-vehicle ECU,
wherein the controller is configured to:
acquire request data related to the service request from the in-vehicle ECU,
specify a service provided to the in-vehicle ECU and a security level when providing the service based on the acquired request data,
generate provision data for providing a service to the in-vehicle ECU based on the specified security level,
output the generated provision data to the in-vehicle ECU, and
specify a security level by referring to a service table stored in an accessible storage area and including setting information related to a security level,
the service table includes a name of an application executed by the in-vehicle ECU, and
the acquired request data includes the name of the application executed by the in-vehicle ECU, and
specifies a security level by referring to the service table based on the name of the application included in the acquired request data.

14. The in-vehicle device according to claim 13, wherein:
a process of generating the provision data based on the security level includes at least one security process among a process of assigning a message authentication code, a process of assigning a digital signature, and a process of encryption a payload included in the provision data, and
the controller varies the security process when generating the provision data according to the specified security level.

15. The in-vehicle device according to claim 14, wherein the controller increases a number of types of security processes included in the process of generating the provision data according to an increase in the security level.

16. The in-vehicle device according to claim 13, wherein the controller is configured to:
change the setting information related to the security level included in the service table when an attack affecting communication in the vehicle is carried out, and
retransmit provision data generated based on the changed security level to the in-vehicle ECU.

17. The in-vehicle device according to claim 13, wherein the controller is configured to:
determine validity of the acquired request data,
output provision data when a result of determining validity is positive, and
output no provision data when the result of determining validity is negative.

18. The in-vehicle device according to claim 17, wherein the controller is configured to:
generate a session key when the result of determining validity is positive, and
output provision data including the session key to the in-vehicle ECU.

19. The in-vehicle device according to claim 13, wherein:
request data from the in-vehicle ECU includes a public key corresponding to a private key held by the in-vehicle ECU, and
the controller outputs provision data encrypted using the public key of the in-vehicle ECU to the in-vehicle ECU.

20. The in-vehicle device according to claim 13, wherein:
a protocol for communication with the in-vehicle ECU is SOME/IP (Scalable service-oriented MiddlewarE over IP),
request data corresponds to Find Service in SOME/IP, and
provision data corresponds to Offer Service in SOME/IP.

21. The in-vehicle device according to claim 20, wherein:
the in-vehicle ECU and the in-vehicle device are configured as a single device, and
communication between the in-vehicle ECU and the in-vehicle device corresponds to communication between applications in the in-vehicle device.

22. An information processing method causing a computer communicatively connected to an in-vehicle ECU mounted in a vehicle to execute processing of:
acquiring request data related to a service request from the in-vehicle ECU,
specifying a service provided to the in-vehicle ECU and a security level when providing the service based on the acquired request data,
generating provision data for providing a service to the in-vehicle ECU based on the specified security level,
outputting the generated provision data to the in-vehicle ECU, and
specifying a security level by referring to a service table stored in an accessible storage area and including setting information related to a security level,
the service table includes a name of an application executed by the in-vehicle ECU, and
the acquired request data includes the name of the application executed by the in-vehicle ECU, and
specifies a security level by referring to the service table based on the name of the application included in the acquired request data.

23. An in-vehicle system comprising:
an in-vehicle ECU mounted in a vehicle; and
an in-vehicle device communicatively connected to the in-vehicle ECU, wherein:
the in-vehicle ECU is configured to:
generate request data related to a service request, and
output the generated request data to the in-vehicle device, and
the in-vehicle device is configured to:
acquire the request data from the in-vehicle ECU,
specify a service provided to the in-vehicle ECU and a security level when providing the service based on the acquired request data,
generate provision data for providing a service to the in-vehicle ECU based on the specified security level,
output the generated provision data to the in-vehicle ECU, and
specify a security level by referring to a service table stored in an accessible storage area and including setting information related to a security level,
the service table includes a name of an application executed by the in-vehicle ECU, and
the acquired request data includes the name of the application executed by the in-vehicle ECU, and
specifies a security level by referring to the service table based on the name of the application included in the acquired request data.

24. The in-vehicle device according to claim 14, wherein the controller is configured to:
change the setting information related to the security level included in the service table when an attack affecting communication in the vehicle is carried out, and
retransmit provision data generated based on the changed security level to the in-vehicle ECU.

25. The in-vehicle device according to claim 15, wherein the controller is configured to:
change the setting information related to the security level included in the service table when an attack affecting communication in the vehicle is carried out, and
retransmit provision data generated based on the changed security level to the in-vehicle ECU.

26. The in-vehicle device according to claim 14, wherein:
a protocol for communication with the in-vehicle ECU is SOME/IP (Scalable service-oriented MiddlewarE over IP),
request data corresponds to Find Service in SOME/IP, and
provision data corresponds to Offer Service in SOME/IP.

27. The in-vehicle device according to claim 15, wherein:
a protocol for communication with the in-vehicle ECU is SOME/IP (Scalable service-oriented MiddlewarE over IP),
request data corresponds to Find Service in SOME/IP, and
provision data corresponds to Offer Service in SOME/IP.

28. The in-vehicle device according to claim 16, wherein:
a protocol for communication with the in-vehicle ECU is SOME/IP (Scalable service-oriented MiddlewarE over IP),
request data corresponds to Find Service in SOME/IP, and
provision data corresponds to Offer Service in SOME/IP.

29. The in-vehicle device according to claim 17, wherein:
a protocol for communication with the in-vehicle ECU is SOME/IP (Scalable service-oriented MiddlewarE over IP),
request data corresponds to Find Service in SOME/IP, and
provision data corresponds to Offer Service in SOME/IP.

30. The in-vehicle device according to claim 18, wherein:
a protocol for communication with the in-vehicle ECU is SOME/IP (Scalable service-oriented MiddlewarE over IP),
request data corresponds to Find Service in SOME/IP, and
provision data corresponds to Offer Service in SOME/IP.
